(19) United States
(12) Patent Application Publication
(10) Pub. No.: US 2005/0165633 A1
(43) Pub. Date: Jul. 28, 2005

(54) Method for reducing adverse effects of a disaster or other similar event upon the continuity of a business

(76) Inventor: Robert C. Huber, Wayzata, MN (US)

Correspondence Address: William K. Weimer;FAEGRE & BENSON LLP, 2200 Wells Fargo Center, 90 South Seventh Street, Minneapolis, MN, 55402-3901, US

(21) Appl. No.: 10/766,693

(22) Filed: Jan. 28, 2004

(51) Int. Cl. G06F 17/60

(52) U.S. Cl. 705/8

(57) ABSTRACT

A method for reducing the adverse effects upon the continuity of a business or the recovery thereof in the event of a disaster to or interruption of the facilities, systems, materials, personnel, or other aspects of or relating to the business.

This application claims the benefit U. S. Provisional Application No. 60/433,131, filed on Jan. 28, 2003.

### BACKGROUND OF THE INVENTION

Disasters to or other major interruptions or events adversely affecting the continuity of a business remain to be significant concerns of those charged with such continuity. In addition to the horrific loss of life on Sep. 11, 2001, the terrorist acts that brought this about also highlighted the need for businesses to have continuity plans for similar disasters or other business interruptions.

Many businesses have failed to employ any significant continuity plan. Others have employed some form of continuity plan, but which were deficient in important respects.

A need exists for a method that provides new approaches to address such important respects.

### SUMMARY OF THE INVENTION

The present invention provides just that, new approaches to business continuity and recovery.

One embodiment of the present invention involves a method for reducing adverse effects upon a business or a recovering business activities in the event of a disaster to or other disruption of use of facilities, systems, materials, personnel, or other aspects of or relating to the business. This can include carrying out research regarding the business and risks of a disaster or disruption as well as interviewing personnel knowledgeable of one or more aspects of the business or the risks of a disaster or disruption to better understand the business and the risks. It can also include training team leaders as to what to do in the event of the disaster or disruption and how to communicate with each other and their respective team members during or after that disaster or disruption, and training team members specific to their areas of responsibility. It can also include estimating time to recover or gain access to servers and applications taking into consideration effects of dependencies of one server or application on another server or application. Further, it can include carrying out simulated events, setting up a contingency organization that would be instituted at the time of the event, and planning for support services for team leaders and team members who would assist with maintaining business continuity or recovering the business.

Another embodiment is a method for reducing adverse effects upon a business or recovering business activities in an event of a disaster to or other disruption of use of facilities, systems, materials, personnel, or other aspects of or relating to the business. This embodiment can include carrying out research regarding the business and identifying risks of a disaster or disruption to the business. It can include identifying computer-related assets used in the business, as well as developing an event plan that is to be executed in the event of the disaster or disruption, wherein the plan is based specifically on the business, at least one of the identified risks, and at least one of the identified computer-related assets.

Another embodiment of the present invention involves a method for maintaining or regaining at least partial activities of a business following an event that prevents or impedes access to at least one asset used in the business. This embodiment can include identifying where within a facility the at least one asset is located and creating a description of the location of the at least one asset. It can further include developing a retrieval plan by which a retrieving entity would retrieve the at least one asset and developing a tracking plan by which a tracking entity that is to retrieve the at least one asset is tracked during retrieval by a tracking entity.

Still other embodiments are described in this application.

### DETAILED DESCRIPTION OF PREFERRED EMBODIMENTS

### INTRODUCTION

U.S. Provisional Application 60/433,131, filed on Jan. 28, 2003, is hereby incorporated herein by reference.

The following is a list of a number of important approaches, one or more or a combination of which may be employed for a given plan or situation. Some of these approaches are explained in greater detail later herein.
Identify essential personnel
Identify critical business functions
Conduct Business Impact Analysis
Track revenue flow through business units
Create recovery teams
Identify key recovery team responsibilities
Identify key recovery team tasks
Develop recovery team training exercise
Conduct team training exercise
Produce recovery document
Finding off-site storage of recovery documents and related materials

The identification of essential personnel includes finding those who know how the business is run and the assets used to run the business. The term asset can include physical assets such as facilities, equipment, files, and the like, and other assets such as data and applications residing on computers, servers, and the like. This approach also includes determining team members and team leaders of the various business continuity teams.

The identification of critical business functions are necessary in order to know the functions to be confirmed or recovered at the time of a disaster or disruption. This approach can enable better prioritization of the recovery of functions as well as illuminate pre-event measures to reduce or avoid the loss or delayed use of these functions.

Conducting a business impact analysis involves learning the effects of loss or delayed use of business assets, including facilities, files, computers, servers, communication equipment, computer applications, data, and so on. This can also identify key customers, clients, suppliers, etc. of the business. This approach can enable the setting of recovery tasks, better prioritization of the recovery tasks, and can illuminate pre-event measures.

Creating recovery teams works is an approach for choosing personnel suited to recover (or maintain) specific business functions. This approach works in conjunction with the results of identifying personnel and business functions and recovery prioritization.

Identification of key recovery team responsibilities involves divvying up the responsibilities so there is no unintended gaps or overlap of responsibilities among teams. This approach, like other approaches mentioned here, can and usually should be tailored to at least a certain degree to suit the specific business.

Development of recovery team training exercises, similarly, can and usually should be tailored to at least a certain degree to suit the specific business. This approach can involve predicting the more likely types of disasters or other disruptions. Once developed, these training exercises should be conducted in order to prepare teams and individuals for a real event and to allow for changes to the recovery plan based on lessons learned from the exercises.

Production of the recovery document creates the means for guiding the teams before, during, and/or after a disaster or other disruption. It can be developed at various stages and can and often times should evolve over time with changes to the business, such as things as simple as changes of location of various assets.

One important aspect of the present invention is its efficiency. It can be condensed into an eight-step approach. And, for example, this approach (as disclosed herein) can be done via an eight-day effort that involves collaboration between the party leading the approach and the client who is to benefit from it. Though shorter or longer periods of time can be used than this eight-day period, it is considered by clients to be best kept to a minimum, but necessary number of days so the results can be achieved and the client's personnel can promptly return to or work in conjunction with their day-to-day duties.

The following several pages contain an example of a task list for a given project, of which one or more or a combination of the listed items may be used in a given plan or situation. The noted items, steps, approaches, and the like are exemplary are replaceable by similar items, steps, approaches, and the like.

Team Leader Responsibilities
Team leaders are responsible for coordinating all recovery activities to re-establish processing to acceptable levels within the shortest timeframe. These individuals do the following:
Serve as the prime decision-maker for situations not included in this plan
Motivate and direct the members of their teams
Create additional recovery positions as needed to assist in recovery activities
Evaluate and critique initial disaster assessment reports and action plans
Submit final disaster assessment reports to the Business Continuity Administrator
Track the actual progress/completion of recovery activities against the projected sequence of recovery events (i.e., function as a project manager for the recovery process)
Work closely with other Business Continuity team leaders to ensure smooth integration of all recovery tasks
Assign team members to the team tasks detailed for each team in each section of the plan
Educate and cross-train team members in special and critical skills. This can have a significant impact on the success of the plan and the amount of time required to execute the plan

Team Leader Tasks
Activate Business Continuity teams as needed, depending upon the disaster circumstances
Establish progress reporting times (hourly, every two hours, etc.) and work with other Business Continuity team leaders to ensure required activities are performed in a timely manner

IT Recovery Team Responsibilities
Assure operation of file and data restoration devices.
Assure operation of LAN and servers.
Assure critical databases are operational.
Assure critical applications are operational.
Assure critical PCs are configured and operational.
Assure IT helpdesk personnel are available.

IT Recovery Team Tasks
Set up local network between Tape backup unit and server farm.
Initiate restoration of servers in documented sequence.
When parallelism is possible, initiate PC restoration.
When database files/partitions have been restored, verify database server operation.
When application files have been restored, verify application operation against appropriate databases.
When PC restoration is complete, verify PC access to applications and databases.
Verify that interim transactional operation is maintaining integrity.

Database Servers Team Responsibilities
Get HP server(s) installed and prepared for use.
Get the HP-based applications restored and available, in the timeframes indicated by the business users.

Database Servers Team Tasks
Contact HP and arrange for server(s) to be delivered to the off-site location, if needed.
Arrange for HP server(s) for use. Create the file system, if needed.
Use the software in the Disaster Recovery bins, as well as the tapes requested from off-site storage, to install the software and restore the data and applications.
Ensure connectivity with the LAN and Citrix.

Equipment Required
Cell Phones
2PC's
At least 1 HP L-class server, with console monitor
At least 1 DLT 8000 tape drive (prefer 2)
Paper, pens, pencils
Disaster recovery bins stored off-site
Latest backup taps stored off-site
Latest database layout documents stored off-site
Internet access
1 printer
2 telephones

IT Applications Team Responsibilities
Notify Applications Recovery Team of situation
Verify functionality and accessibility to applications and data
Get check printing software and printer setup

IT Applications Team Tasks
Call and mobilize members of the Applications Recovery Team
Contact CSS recovery team to verify access
Load check software on stand-alone PC and connect to MICR printer
Assist users Regularly report progress/status to IT Recovery Team Leader

Equipment Required
Cell phones
Tablets, pens
PayBase (check printing) software from off-site storage
PC for check printing
Two PC's for Development staff
Laser printer with MICR toner cartridge

IT Desktop PC's Team Responsibilities
Get desktop PC's set up and prepared for use by only those that need them during the crisis (number of PC's to be determined).
Follow up with anyone regarding the PC's and issues or additional requirements.

IT Desktop PC's Team Tasks
Obtain PC's, software and documentation necessary for installation and ghosting of PC's (this may require waiting for the LCCM (Ghost) server to be rebuilt—up for discussion).
Prep PC's for installation
Install necessary ghost images and software on each PC according to needs.
Test and implement completed PC's.
Follow up with users regarding additional needs or issues.

Equipment Required
Three PC's or laptops for use by IT Desktop Support staff (includes CPU, Monitor, mouse, Keyboard)
One Ghost server (this may be part of the telecomm/server BCP plan-check).
Paper, pens and pencils
Latest backup tapes stored off-site to provide Ghost server restoration, software that is currently on the network and documentation for software installations.
Internet access for possible online troubleshooting information (MSKB, ect).
One color laser printer
Three phones

Communications Team Responsibilities
Get NT server(s) installed and prepared for use.
Get the NT-based applications restored and available, in the timeframes indicted b business users.
Get network infrastructure setup and ready for server (s) and internet traffic.
Get communications environment restored for trucks, customers and employees, in the timeframes indicted by the business users.

Communications Team Tasks
Contact Nexus information Systems and arrange for server (s) to be delivered to the off-site location if needed
Arrange for Nexus technical personnel to assist with installation, if needed.
Prepare the Compaq server (s) for use. Create the file system, if needed.
Use the software in the Disaster Recovery bins, as well as the tapes requested from off-site storage, to install the software and restore the data and applications.
Ensure connectivity with the LAN, Internet and ASP networks.
Contact Qwest and arrange for voice/data circuits to be setup at recovery site.
Contact GRE and arrange for two-way radio circuits to be setup at recovery site.
Contact Hickory Tech and arrange for PBX to be setup and delivered to the off-site locations, if needed
Contact Verizon Wireless and Nextel and arrange any cell phone needs

Equipment Required
Cell phones
3PC's
At least 3 Compaq 380 or 580-class server, with console monitor
At least 1 SDLT Compaq tape drive (prefer 2)
Paper, pens and pencils
Disaster recovery bins stored off-site
Latest backup tapes stored off-site
Latest network, servers and communications layout documents stored off-site
Internet access
1 laser printer
3 phones

Crisis Management Team Responsibilities
Account for all employees.
Determine causalities, injured, etc.
Determine the welfare of non-hospitalized employees.
Notify employees when they can return to work and where they will be located.
Provide benefit assistance to employees and employees' families.
Coordinate counseling services/EAP for employees and employees' families.
Monitor employee well being and needs.

Crisis Management Team Tasks
Conduct head account (see appendix for list).
Determine who is injured.
Contact family members of injured
Designate employee communication methods (hotline, bulletin board, etc.) for two-way communication
Communicate with employees' status/condition injured employees.
Communicate to employee when they can return to work and where.
Distribute EAP and other benefit contact information.
Coordinate resources for employee needs (counselors, etc.).
Assist the Disaster Management team in setting up alternate site equipment/software
Assist in mobile communication efforts with available truck fleet equipped with company two-way radios.

Equipment Required
Desk/chairs
Office supplies-pens, paper etc.
Cell phones
Map books
Computers/printers

News Release Team Responsibilities
Get timely information from team leaders (crisis communication leader)
Send out timely media releases, keeping media informed on status/progress of disaster
Provide media access to appropriate spokespeople
If media is on site, ensure they have a guide/spokesperson

News Release Sub-Team Tasks
If media is on site, ensure they have a guide/spokesperson
Arrange news conferences (if the disaster is large)
Email/fax out news releases

Safety and Security Team Responsibilities
Securing the new work location.
Providing a safe work environment at the new location.
Provide security for damaged site.

Safety and Security Tasks
Providing a means of identifying Connexus employees to enter the new facility.
Verify that any new vehicles, equipment, and tools are in safe operating condition, and meet our company safety requirements.
Develop a communication plan to employees on company safety and security at the new location.
Qualify contractors that may be working at the new site.
Keep a current list of employee/contractors, and their required access to various company functions.
Monitor our current site, and provide information on entry of the damaged facility and the overall status of the damaged facility.

HR Team Responsibilities
Account for all employees.
Determine causalities, injured, etc.
Determine the welfare of non-hospitalized employees.
Notify employees when they can return to work and where they will be located.
Provide benefit assistance to employees and employees' families.
Coordinate counseling services/EAP for employees and employees' families.
Monitor employee well-being and needs.

HR Team Tasks
Conduct head account (see appendix for list).
Determine who is injured.
Contact family members of injured
Designate employee communication methods (hotline, bulletin board, etc.) for two-way communication
Communicate with employees' status/condition injured employees.
Communicate to employee when they can return to work and where.
Distribute EAP and other benefit contact information.
Coordinate resources for employee needs (counselors, etc.).

Equipment Required
Cell phones
Computer
Employee database (Lawson benefits module) stored off-site
Benefit contact list stored off-site

Finance and Payroll Team Responsibilities
Produce & Maintain Payroll Records & Reports
Produce A/P Payments & Maintain Accounts Payable Records
Produce Financial Statements & Management Reports

Finance and Payroll Team Tasks
Determine next payday
   If pay day is within 0-72 hours—make arrangements for employees to be paid in cash:
      Pay employee's previous net pay amount.
      Communication to employee's of where payment is to be made: managers to notify their direct reports employee's of pay site
      Set up recording on employee “hot line” with pay site
      Get cash from bank or arrange for payment to be made at bank (Wells Fargo Main & Hwy 10)
   If pay day is beyond 72 hours—duplicate previous pay period or base all employees on 80 hours if time permits
Hold mail at post office until temporary work site is established
Notify any critical vendors of disaster (Use pre-printed labels of vendor file stored off site)
   Arrange for funds from line of credit as needed (CFC Money Desk)
Financial statement process can be put on hold for first 72 hours
Notify CFC of disaster situation

Equipment Required
Within 72 hours:
   Computers 2
   Desks 2
   Phones 2
   Calculator 2
   Printer 4SI 1
   Modem 56k V90 Software 1
   Lawson
   Windows 2000
After 72 Hours:
   Computers 6
   Desks 6
   Phones 6
   Calculator 6
   Lawson
   Maximo
   Banner

Offsite Storage
Pre-printed labels of current vendor file with addresses (in case computers aren't available)
Current employee listing with phone numbers, address and pay rate (in case computers aren't available)

Logistics Team Responsibilities
Address immediate logistics issues, such as helping to establish the Disaster Command Center. Facilitate the ordering and delivery of office furniture, supplies, and equipment.
Arrange for transportation of staff, equipment, supplies and other necessary items between sites
Arrange for delivery of food to staff at Command Center, Recovery Site and any other location where personnel may be working
Notify vendors of business recovery and recovery site locations.
Provide clerical and administrative support for all other teams.
Assist in development of important support services such as mail and delivery services
Maintain activity logs to document the entire Recovery Team's activities and financial transactions.
Survey building and grounds to determine extent of damage to building, equipment, and critical material. Assess damage and make recommendations on what additional equipment or supplies are needed to recover core business.
Coordinate the identification of purchases, contact suppliers; administer and monitor the procurement and delivery process.
Arrange for transportation of salvaged and newly purchased equipment and supplies to alternate sites.
Advise Command Center of status and progress.
Unload and document all material received at alternate sites.
Review plans, policies, and procedures and submit changes as required.
Train newly assigned team members.
Ensure staff coverage on a 24 hour per day basis

Logistics Team Tasks
Arrange for delivery of materials stored off-site to recovery site.
Coordinate the ordering and movement of equipment, office furniture, and staff to temporary facilities.
Contact maintenance and service contractors to provide basic support services.
Contact vendors and suppliers of recovery plan and addresses of recovery sites.
Secure transportation requirements
Coordinate the delivery of food to staff at all locations.
Conduct survey and assess damage to building, grounds, equipment, and inventory.
Make recommendations on salvageable equipment or inventory.
Identify requirements critical to core business.
Arrange loading and delivery of salvaged items if needed to alternate site.
Contact appropriate suppliers
Procure all requirements and monitor the acquisition process.
Arrange travel and lodging requirements needed for employees, contractors, or suppliers.
Arrange freight and logistics for salvaged and new material to alternate sites
Maintain activity logs on all activities and financial and purchasing transactions.
Inform Postal Service of recovery site location for mail delivery.
Alert courier services of recovery status and recovery addresses to facilitate immediate deliveries between alternate site locations.
Unload salvaged and newly purchased material at alternate site
Document receipts and condition of purchased and salvaged material
Provide clerical and administrative support.
Keep Command Center and team leaders informed of status and progress.
Train new team members
Maintain 24 hour per day coverage

Off-site Storage Team Responsibilities
Retrieve necessary materials/documents from off-site storage.
Provide clerical and administrative support for all other teams.
Train newly assigned team members.

Off-site Storage Team Tasks
Arrange for delivery of materials/documents stored off-site to recovery site.
Assist appropriate teams with basic coordination and support staff.

Vendor Contact Team Responsibilities
Coordinate the identification of purchases
Contact Vendors to procure necessary equipment, software and supplies
Notify venders of business recovery and recovery site locations and phone information.
Order and replacement and temporary equipment as necessary for continued operation.

Vendor Contact Team Tasks
Contact appropriate maintenance/repair contractors and approved suppliers in the event of extensive facility damage using the vender phone list.
Arrange for continued service, delivery of material and freight services at alternate site, if necessary.

Damage Assessment Team Responsibilities
Perform survey of damage to building and equipment
Inform Logistics Team Leader of status of damage to building and equipment/inventory stored in yard.
Identify salvageable material and equipment in building and yard. Assist Shipping and Receiving Team in preparation of material.

Damage Assessment Team Tasks
Make introductions and clarify responsibilities to police and emergency authorities.
Obtain access rights to building and grounds.
Conduct preliminary walk through of building and grounds to determine severity of damages.
Provide continual updates to Logistics Team Leader on status of building and grounds.
Document severity of damage and record possible salvageable material and equipment.
Provide list to Logistics Team Leader.
Assist Shipping and Receiving Team in identification of salvageable material and equipment
Assist other teams as assigned

Shipping and Receiving Team Responsibilities
Shipping
Receiving
Document and prepare required documents

Shipping and Receiving Team Tasks
Prepare material for shipment using traditional and approved methods.
Prepare shipping documentation and appropriate bills of lading.
Receive material in accordance with approved process.
Document receiving and shipping transactions.

Facilities Recovery Team Leader Responsibilities
Gain access to predetermined recovery sites.
Oversee recovery responsibilities of team members

Team Leader Tasks
Contact team members and let them know that we are going to the recovery plan and to stay by the phone for a call back within the hour.
Call selected site(s) and let them know we will be coming.
Call Logistics Support and ask him to order the predetermined material for the selected site(s).
Contact team members and have them report to selected site(s) to start putting together workstations and setting up power if needed.

Facilities Team Responsibilities
Team Leaders will call their team members whom they have selected and have them report to predetermined recovery sites to assist them in their responsibilities with the recovery.

Team Tasks
Set up workstations
Set up power to recovery site
Set up heat or air conditioning to recovery site
Set up sanitation for site
Set up security for recovery site
After recovery set ups are completed, maintain environmental conditions and supplies for employees.
   * * Please See Technical Support Contact for all phone numbers* *

Accounting & Finance Team Responsibilities and Tasks
1. Power Billing
Create & Process Invoices
Post to General Ledger
2. A/P, A/R, Cash Management
Pay bills via wire transfers or written checks
Investment and member investment transactions
Prepare and make deposits
Maintain records of transactions
3. Material & Supply Inventory
Record the receipt of items into inventory
Record the issuance of items from inventory
4. General Ledger
Post journal entries
Close books
Create Financial Reports
Create budget
5. Activities and Asset Management
Set up projects
Capture costs
Update ledger
Capitalize costs
6. Taxes
Calculate, accrue, and pay the following taxes: Income, Sales & Use, Payroll, Property
7. Long Term Debt
Record new debt
Accrue interest on existing debt
Make debt service payments
8. Insurance
Purchase insurance to cover needs
Process claims

Minimum System Requirements
All Lawson modules
Desktop software such as Excel, Word, Access etc.
Billing system—MV-90, Lodestar, Bill Print, DSMR and the Hist database
Internet connections
Project Management System
The Accounting Services and Financial Services departments need all of our existing software to be operational for us to perform our essential functions.

Groups we are Dependent Upon
System Operations
Administrative services
Warehouse
Human Resources
Information Services

Crisis Management Team Responsibilities
Work with the Damage Assessment group to obtain information on damage assessment structure and injuries to staff members.
Work with the HR group for updates on the status of accounted for/injured staff members.
Serve as spokesperson when communicating with the media concerning the emergency situation.
Monitor and maintain ongoing communication efforts to provide the media with progress reports.
Serve as spokesperson when cooperating with law enforcement officials.
Advise the Executive Director of the status and progress on communication efforts.
Review plans, policies, and procedures concerning Business Continuity communication efforts and update as necessary.
Train newly assigned team members.
Have fax machine in alternate location set up with media contact fax numbers to communicate information.

Crisis Management Team Tasks
Assist in assessing damage (structure and staff injuries).
Meet with the media (initial and ongoing communication efforts) to address inquiries concerning the emergency.
Coordinate communication with law enforcement officials.
Meet with staff to gather updated information.
Draft/send media press releases from alternate location.

News Release Team Responsibilities
Work with the Damage Assessment group to obtain information on damage assessment
Work with the HR group for updates on the status of accounted for/injured staff members.
Serve as spokesperson when communicating with the media concerning the emergency situation.
Monitor and maintain ongoing communication efforts to provide the media with progress reports.
Serve as spokesperson when cooperating with law enforcement officials.
Advise the BCA of the status and progress on communication efforts.
Review plans, policies, and procedures concerning Business Continuity communication efforts and update as necessary.
Train newly assigned team members.
Have fax machine in alternate location set up with media contact fax numbers to communicate information.

News Release Sub-Team Tasks
Assist in assessing damage (structure and staff injuries).
Meet with the media (initial and ongoing communication efforts) to address inquiries concerning the emergency.
Coordinate communication with law enforcement officials.
Meet with staff to gather updated information.
Provide media press releases.

HR & Payroll Team Responsibilities
Contact appropriate vendors (see Appendix D)
Coordinate getting access to all HR software (Lawson, Excel, Work, Access, Outlook, etc)
Retrieve employee data from Lawson database—need list of all active employees by department and/or supervisor, emergency contact information, and any other pertinent data (see hard copy employee listing in appendix B)
Coordinate back-up payroll site(s) if necessary
Primary site—USG office bldg
Secondary site—GRE ND
Other options—3^{rd} party vendor
Arrange for onsite EAP Counselors
Work with Supr/Mgrs to account for all employees
Notify Emergency Contacts if applicable
Contact both labor unions (LU160 & LU1593)
Assess staffing needs if appropriate
Account for all employees.
Determine the casualties, injured, etc.
Notify employees at other locations of the situation.
Determine the welfare of unhospitalized employees.

System/Office Immediate Needs
Computers (at least 2) with the following software:
Lawson
Excel
Word
Access
Outlook
Printer
Phones
Fax
Check stock

Third Party Assistance
Payroll outsourcing vendor
EAP
Employment agencies

HR & Payroll Team Tasks
Conduct a head count.
Determine who is injured, which medical facility they have been taken to, and their condition.
Contact family members and let them know the location of the injured employee.
Determine casualties and which medical facility they have been taken to.
Work with the police/hospital and the police/hospital chaplain to notify family members of casualties.
Notify employees at other locations of the situation.
Notify employees when they will be coming back to work and where they will be located).
Talk with employees to determine how they are handling the situation and determine what assistance we can provide to them and their immediate family members.
Coordinate counseling services for employee's family members.

Safety & Security Team Responsibilities
Secure the Information Services recovery site (Connexus)
Secure the damaged Great River Energy location(s)/facility(ies)
Secure the business recovery site (Northland Inn)
Maintain personal safety and security for Great River Energy employees
Maintain worker integrity
Set up perimeters.
Review plans and procedures, submitting changes as required.
Maintain communication with Command Center.
Assist Human Resources with headcount.
Monitor unusual behavior.

Safety & Security Team Tasks
Team Leader Tasks
Contact team members based on information received from the Crisis Management Manager
Verify that team member(s) are on site and that tasks are being completed
Advise the Crisis Manager and Disaster Recovery Administrator of status/progress
Activate retrieval of off-site safety/security recovery material/items
Review the plan annually and update as necessary

Team Tasks
Meet/coordinate with appropriate authorities such as law enforcement, fire department, National Guard, city officials, and the Damage Assessment Team
Secure the disaster site after the authorities leave the scene, establishing perimeter security at the site, guard services, looting prevention, etc.
Allow only authorized personnel on GRE sites—check ID's
Secure the I.S. Recovery Site and the Business Recovery Site
Monitor employees for their well being—unusual behavior, illegal drugs, alcohol, depression
Transport staff to appropriate work locations as required
Bring safety/security recovery material from the off-site storage location to the disaster site

Safety Security Recovery Item Checklist
Flashlights
Walkie Talkies (two way radios)
GRE I.D. Security vests
Nightsticks
Hardhats, gloves, and other personal protective equipment
“Do Not Enter” rolls of tape
Sign In Sheet with Clipboard

Team Responsibilities
Train team members
Receive calls from business units
Receive calls from member cooperatives and provide updates
Confirm IT restore times by business unit
Confirm IT restore times by IT function

Team Tasks
Initiate emergency call center.
Act as a help desk to coordinate calls between Recovery Management Team members.
Receive information from IT recovery team and provide that information to system users.
Obtain updates from IT recovery team and pass on information to business units, as required.
Create phone log

Needs and Equipment
Whiteboard (for updates)
3 laptop computers
3 phones with 2 lines each
3 workstations
Contact log

Phone Support Team Responsibilities
Train team members
Receive calls from IT users
Receive calls from business units
Receive calls from member cooperatives
Confirm IT restore times by business unit
Confirm IT restore times by IT function
Update team plan, as necessary

Phone Support Team Tasks:
Act as a help desk to coordinate calls between Recovery Management Team members
Answer phone calls—obtain response (forward or answer call)
Receive information from IS Recovery Team and provide that information to system users
Obtain updates from IS Recovery team and pass on information to business units as required
Log phone calls

Logistics Team Responsibilities:
Arrange for transport of personnel, equipment and supplies to command center and recovery center.
Assist Vendor Contact Team in procuring equipment and supplies
Arrange for basic support services required for operations (delivery services, catering, etc.)
Provide clerical and administrative support for all other teams
Coordinate the identification of purchases Contact vendors to procure necessary equipment, software and supplies
Monitor acquisition and delivery of purchases
Advise Command Center of status and progress
Coordinate the procurement and disposition of operation supplies
Coordinate the shipment and delivery of hardware
Coordinate customer input and output deliveries
Review plan, policies and procedures; submit changes as required
Develop and execute exercise scenarios for all team responsibilities
Train newly assigned team members
Identify tasks not outlined in the plan
Obtain service for equipment as needed
Purchase new or replacement items as needed
Obtain maintenance for equipment as needed
Order replacement and temporary equipment as necessary for continued operation

Logistics Team Tasks
Contact all vendors from list as necessary and provide them with the recovery site address and phone number
Arrange for continued service at alternate location
Arrange for the delivery and transfer of all essential materials, resources, hardware and critical items to desired location(s).
Arrange and provide all basic support services required for effective office operations.
Secure and provide necessary transportation requirements (i.e. heavy equipment, trailers, vehicle rental, utilization of ND state vehicles & drivers, couriers, air travel, hotel accommodations, food, water, food delivery/caterers, day care, clerical/administrative support personnel, general supply services, etc.).
Communicate with all local Police, Sheriff's Department, State Highway Patrol Officials, and other Emergency Services personnel.
Communicate with Local, State and Federal Emergency Operations Center(s) (EOC's).
Communicate and coordinate with local medical facilities.

Off-Site Storage Team Responsibilities

Responsible for list of material stored off-site
Off-site storage vendor contact phone numbers (Appendix N)
Off-site storage facility retrieval procedures (Appendix I)
List of GRE employees having access to stored material
List of GRE employees authorized to store material
List of material stored off-site (Appendix K)
Identify what records are needed during a business recovery
Identify critical records for each department, in cased it is a localized problem
Identify which records are needed when (first 2 hrs, first day, first week)
Procure, copy, protect these records
Arrange for transportation of materials to recovery site
Advise command center of status and progress
Review plan, policies and procedures; submit changes as required
Develop and execute exercise scenarios
Train newly assigned team members

Off-Site Storage Team Tasks
Maintain up-to-date information
Develop and maintain off-site storage and retrieval procedures

Vendor Contact Team Responsibilities
Contact all of the appropriate vendors and provide information relative to the following:
Obtain service for equipment as needed
Purchase new or replacement items as needed
Obtain maintenance for equipment as needed
Provide recovery site address and phone information
Order replacement and temporary equipment as necessary for continued operation

Vendor Contact Team Tasks
Contact all vendors from list as necessary and provide them with the recovery site address and phone number
Arrange for continued service at alternate location

Damage Assessment & Salvage Team

This team is primarily responsible for an initial damage assessment, a detailed damage assessment, loss minimization, and salvage operations.

Accurate assessment is crucial for appropriate corrective actions. In assessing the disaster, the Damage Assessment and Salvage Team does the following:
Estimates the outage duration
Determines outage impact
Re-evaluates the situation every hour and provides input to management

Depending on the assessment input from the Damage Assessment and Salvage Team, Great River Energy management along with the Business Continuity Administrator will activate the Recovery Management Team.

Damage Assessment & Salvage Team Responsibilities
Contact police and fire department for disaster authorization
Assist team leaders with assessing damage
Arrange for salvaged items to be available for use
Coordinate procurement and installation of replacement equipment
Coordinate facility damage cost estimate and repair
Recycle non-usable resources
Review plan, policies, and procedures and submit changes as required
Develop and execute exercise scenarios for all team responsibilities
Train newly assigned team member

Damage Assessment & Salvage Team Tasks
Arrange for disaster site security (in conjunction with Great River Security)
Perform preliminary assessment of equipment damage and operability
Take inventory of salvageable hardware and facilities
Provide detailed inventory of damage to facility
Provide detailed inventory of damage to contents
Photograph all damages for insurance purposes
Arrange protection for undamaged and salvageable hardware
Evaluate environmental surroundings
Provide detailed debriefing/damage assessment report
Determine building safety, report to Disaster Management Team
Determine items that can be immediately salvaged and put into use
Determine items that can be used after repair
Determine which equipment cannot be salvaged

Salvage Team Instructions

None of this hardware is crucial to rebuilding the systems; it just speeds up the process tremendously if any of it is still functional.
Archive tapes stored in vault in Bldg 1 if available.
StorageTek L700 and greap001 (Sun Ultra 3000) in Bldg 1 Computer Room if both functional.
SAN Hardware if not damaged in computer room in Bldg 1 Computer Room.
Server Hardware in Bldg 1 Computer Room (see server list for importance)
Any Cisco hardware still functional. Most importantly the hardware in Bldg1 Computer Room, Followed by the hardware in Bldg 2 Computer Room, then all the two network closets.
KVM hardware if operational in Bldg 1 Computer Room.

Needs List
Protective clothing
hard hats, boots
flashlights
digital camera/video camera
cell phones

Facilities Recovery Team Responsibilities
Find out nature of problem and how long estimated time of emergency
Notify command center (such as Northland Inn)
Call contacts for communication units, phones, etc.
Call contacts for furniture set ups
Line up with contacts on proper transportation or delivery of products to command center.
Miscellaneous supplies will come from (Home Depot—open 24 hours), Menards, Office Deport, etc.
Call people on team to align them for work duties and where and when to report.

Facilities Recovery Team Tasks
Have rooms for at least 20-30 people available and area for 40 workstations (tables, desk and chairs).
Have some sort of backup transportation (rental trucks, cars, etc)
Have contacts in place for long-term (more than a week) on furniture rentals (C.F.S. furniture company on stand by)

Communications Team Responsibilities
Assist in damage assessment
Advise the Command Center of status and progress
Coordinate restoration of service with vendors
Monitor restoration of normal communication operation
Ensure availability of necessary test equipment
Ensure software is properly backed up and rotated to off-site storage
Establish procedures with local carriers for testing and installation of temporary voice/data lines at the backup facility
Assure network connectivity is available between interim IS data center and interim GRE business facility
Monitor and maintain communications
Implement and support the support strategies for communications of business unit recovery
Coordinate new line orders and/or revisions of existing circuit configuration
Periodically review and revise the communications equipment configuration
Review plan, policies, and procedures; submit changes as required
Develop and execute exercise scenarios for all team responsibilities
Train newly assigned members

Communications Team Tasks
Network Tasks
Identify equipment and software requirements
Restore data communications links between users and computers, regardless of location
Test data communications operation
Establish data communications for critical applications

Telecom Tasks
Re-establishing voice and data communication systems.
Accompany recovery equipment to recovery site destinations
Acquisition and install required hardware configurations
Contact Telcom personnel at OTP, MPC, MP, Xcel

The following is an example of an emergency procedures, one or more or a combination of which may be used for a given plan or situation:

Summary of Emergency Procedures

Upon notification that a disaster has occurred and that the group is operating under temporary emergency conditions, the following list outlines the order of events. The following steps should be followed according to the level of disaster to which they relate.

| | |
|---|---|
| All | Relates to all disasters. |
| Level 2 | Relates to disaster level two. |
| Level 3 | Relates only to disaster level three. |

The disaster levels are defined by the following criteria.
Level 1 (Problem): A resolution takes up to 24 hours. It involves minor equipment breakdown, partial loss of network, major program error, contaminated databases, etc.
Level 2 (Emergency): A resolution takes up to 24-48 hours. Moderate damage to facility and/or the computer equipment is observed.

Level 3 (Disaster): A resolution takes over 48 hours. It involves major facility and/or computer equipment damage. All functions and personnel are moved to a recovery site(s).

Disaster Level - One (All disasters)

| Step | Responsibility | Description |
|---|---|---|
| 1. | Employee | Notifies the supervisor immediately of a problem |
| | | affecting the critical business functions. |
| 2. | Supervisor | Confirms the problem, determines appropriate |
| | | action and estimates length of time to resolve. |
| | | A Level 1 problem resolution takes up to 24 |
| | | hours. It involves minor equipment breakdown, |
| | | partial loss of network, major program error, |
| | | contaminated databases, etc. |
| 3. | Supervisor | Notifies managers that normal operations may |
| | | resume. |

Disaster Level - Two

| Step | Responsibility | Description |
|---|---|---|
| 1. | Employee | Notifies the supervisor immediately of a problem |
| | | affecting the critical business functions. |
| 2. | Supervisor | Identifies that a level 2 disaster has occurred |
| | | and immediately notifies the Disaster Recovery |
| | | Administrator. |
| 3. | Disaster | Confirms level of disaster, determines appro- |
| | Recovery | priate level of action. Contacts the Disaster |
| | Administrator | Management Team members, thus activating the |
| | | Disaster Recovery Plan. If necessary, the |
| | | Disaster Recovery Administrator provides the |
| | | time and place to set up a command center and |
| | | provides additional instructions regarding |
| | | other employees and the use of the recovery |
| | | site. |
| 4. | Team Leaders | Place calls to all of their team members and |
| | | provide instructions on dress, meeting location, |
| | | and any other information from the Disaster |
| | | Recovery Administrator, upon notification that |
| | | the Disaster Recovery Plan has been activated. |
| | | It is not necessary for any employee to confirm |
| | | the disaster or level of disaster after initial |
| | | notification. |
| 5. | Team | Report their findings and estimates only to |
| | Members | their team leaders, who are their points of |
| | | contact. This prevents multiple versions of |
| | | loss estimates or inconsistent recovery infor- |
| | | mation from reaching the Disaster Recovery |
| | | Administrator. |
| 6. | Disaster | Determines that operations can safely and |
| | Recovery | productively return to the main facility or |
| | Administrator | some other permanent location. Until deter- |
| | | mination is made, operations continue under |
| | | the temporary emergency conditions. |
| 7. | Disaster | Notify managers that normal operations may |
| | Recovery | resume and all teams may be disbanded. |
| | Administrator | |

Disaster Level - Level Three

| Step | Responsibility | Description |
|---|---|---|
| 1. | Employee | Notifies the supervisor immediately of a |
| | | problem affecting the critical business |
| | | functions. |
| 2. | Supervisor | Identifies that a level 3 disaster has |
| | | occurred and immediately notifies the |
| | | Disaster Recovery Administrator. |
| 3. | Disaster | Confirms level of disaster, determines |
| | Recovery | appropriate level of action. Contacts the |
| | Administrator | Disaster Management Team members, thus |
| | | activating the Disaster Recovery Plan. If |
| | | necessary, the Disaster Recovery Admini- |
| | | strator provides the time and place to set |
| | | up a command center and provides additional |
| | | instructions regarding other employees and |
| | | the use of the recovery site. |
| 4. | Team Leaders | Place calls to all of their team members |
| | | and provide instructions on dress, meeting |
| | | location, and any other information from |
| | | the Disaster Recovery Administrator, upon |
| | | notification that the Disaster Recovery |
| | | Plan has been activated. It is not neces- |
| | | sary for any employee to confirm the |
| | | disaster or level of disaster after initial |
| | | notification. |
| 5. | Team Leaders | Provide clear instructions to their team |
| | | members. These instructions include: |
| | | Obtaining damage estimates |
| | | Estimating salvage probabilities |
| | | Performing salvage operations |
| | | Estimating recovery time |
| | | Setting up operations at the recovery site |
| | | Resuming operations under emergency |
| | | conditions. |
| 6. | Team Members | Report their findings and estimates only |
| | | to their team leaders, who are their |
| | | points of contact. This prevents multiple |
| | | versions of loss estimates or inconsistent |
| | | recovery information from reaching the |
| | | Disaster Recovery Administrator. |
| 7. | Team Leaders | Update the Disaster Recovery Administrator |
| | | at regular intervals. |
| 8. | Disaster | After the initial operations are under way |
| | Recovery | and preliminary salvage assessments have |
| | Administrator | been made, some teams may be disbanded. |
| | | However, the Contingency Organization is |
| | | still in effect until operations are |
| | | stabilized at all recovery locations. |
| 9. | Disaster | Determines that operations can safely and |
| | Recovery | productively return to the main facility |
| | Administrator | or some other permanent location. Until |
| | | determination is made, operations continue |
| | | under the temporary emergency conditions. |
| 10. | Disaster | Notifies managers that normal operations |
| | Recovery | may resume and all teams may be disbanded. |
| | Administrator | |

Still other embodiments of the invention are contemplated. For example, as previously noted, several embodiments of the invention are listed and described above. Combinations of these embodiments, aspects of these embodiments, and variations thereof are contemplated by the applicant as part of the invention.

1. A method for reducing adverse effects upon a business or a recovering business activities in the event of a disaster to or other disruption of use of facilities, systems, materials, personnel, or other aspects of or relating to the business, comprising:
(a) carrying out research regarding the business and risks of a disaster or disruption;
(b) interviewing personnel knowledgeable of one or more aspects of the business or the risks of a disaster or disruption to better understand the business and the risks;
(c) training team leaders as to what to do in the event of the disaster or disruption and how to communicate with each other and their respective team members during or after that disaster or disruption;
(d) training team members specific to their areas of responsibility;
(e) estimating time to recover or gain access to servers and applications taking into consideration effects of dependencies of one server or application on another server or application;
(f) carrying out simulated events;
(g) setting up a contingency organization that would be instituted at the time of the event; and
(h) planning for support services for team leaders and team members who would assist with maintaining business continuity or recovering the business.

2. The method of claim 1, wherein support services comprises daycare services.

3. The method of claim 1, wherein setting out a contingency organization comprises creating a contingency organizational chart and communicating that authority is given to the organization in the event of a disaster or disruption.

4. The method of claim 1, wherein at least one of the steps is at least partially completed using a computer.

5. The method of claim 1, wherein steps (a) through (h) are carried out in order.

6. A method for reducing adverse effects upon a business or recovering business activities in an event of a disaster to or other disruption of use of facilities, systems, materials, personnel, or other aspects of or relating to the business, comprising:
(a) carrying out research regarding the business;
(b) identifying risks of a disaster or disruption to the business;
(c) identifying computer-related assets used in the business; and
(d) developing an event plan that is to be executed in the event of the disaster or disruption, wherein the plan is based specifically on the business, at least one of the identified risks, and at least one of the identified computer-related assets.

7. The method of claim 6, further comprising training team members as to their roles within the plan.

8. The method of claim 7, wherein the step of training team members comprises training team leaders as to how to communicate with each other and their respective team members during or after the disaster or disruption.

9. The method of claim 6, further comprising carrying out at least one simulated event.

10. The method of claim 9, further comprising adjusting the plan during or after carrying out the at least one simulated event.

11. The method of claim 6, further comprising setting up a contingency organization that would be instituted at the time of the event.

12. The method of claim 6, wherein the business continuity plan further comprising planning for support services for team leaders and team members who would assist with maintaining business continuity or recovering the business.

13. The method of claim 6, wherein the event plan comprises a plan to do at least one of maintaining business continuity and recovering at least one aspect of the business.

14. The method of claim 6, wherein the step of carrying out research comprises interviewing personnel knowledgeable of one or more aspects of the business or the risks of a disaster or disruption to better understand the business and the risks.

15. The method of claim 6, wherein the step of identifying computer-related assets comprises identifying software applications and servers used in the business.

16. The method of claim 6, further comprising estimating an amount of time to recover or gain access to computer-related assets.

17. The method of claim 16, wherein the estimating step comprises taking into consideration including the effects of dependencies of at least one server or application on another server or application.

18. A method for maintaining or regaining at least partial activities of a business following an event that prevents or impedes access to at least one asset used in the business, comprising:
(a) identifying where within a facility the at least one asset is located;
(b) creating a description of the location of the at least one asset;
(c) developing a retrieval plan by which a retrieving entity would retrieve the at least one asset; and
(d) developing a tracking plan by which a tracking entity that is to retrieve the at least one asset is tracked during retrieval by a tracking entity.

19. The method of claim 18, wherein the step of creating a description comprises creating a diagram that shows the location of the at least one asset.

20. The method of claim 18, wherein the tracking plan comprises the retrieving entity taking the retrieved asset to a location at which it may be used or kept for storage or future use.

21. The method of claim 20, wherein the tracking plan comprises providing communications between the tracking entity and the retrieving entity during retrieval.

23. The method of claim 18, wherein the retrieving and tracking entities are humans.
